(19) United States
(12) Patent Application Publication
(10) Pub. No.: US 2025/0005332 A1
(43) Pub. Date: Jan. 2, 2025

(54) PROCESSING APPARATUS, DEVICE, METHOD, AND RELATED PRODUCT

(71) Applicant: Cambricon (Xi'an) Semiconductor Co., Ltd., Xi'an (CN)

(72) Inventors: Yong YU, Xi'an (CN); Yiwei WANG, Xi'an (CN); Xuyan MA, Xi'an (CN); Zhoushuke DING, Xi'an (CN); Shaoli LIU, Xi'an (CN)

(21) Appl. No.: 18/575,535

(22) PCT Filed: Jun. 20, 2022
(86) PCT No.: PCT/CN2022/099772

§ 371 Date: Dec. 29, 2023

(30) Foreign Application Priority Data
Jul. 9, 2021 (CN) 202110778076.7

(51) Int. Cl. G06N 3/0464; G06N 3/08

(52) U.S. Cl. CPC G06N 3/0464; G06N 3/08

(57) ABSTRACT

An on-chip system for neural network operating is applied in a computing processing apparatus included in a combined processing apparatus, which includes one or more data processing apparatuses. The combined processing apparatus also includes an interface apparatus and other processing apparatuses. The computing processing apparatus interacts with other processing apparatus to jointly complete a computing operation specified by users. The combined processing apparatus further includes a storage apparatus, which is connected to the apparatus and other processing apparatus, respectively. The storage apparatus is used to store data of the apparatus and other processing apparatus. By converting the data type of the operation result of the neural network, the algorithm precision is improved and the power consumption and cost of computation are reduced. In addition, the disclosed scheme also improves the performance and precision of the intelligent computing system as a whole.

### CROSS REFERENCE OF RELATED APPLICATION

The present application claims priority to Chinese Patent Application No. 202110778076.7 with the title of “PROCESSING APPARATUS, DEVICE, METHOD, AND RELATED PRODUCT” filed on Jul. 9, 2021.

### TECHNICAL FIELD

The present disclosure generally relates to the field of artificial intelligence. More specifically, the present disclosure relates to a processing apparatus, a device, a method for neural network operating, and related products.

### BACKGROUND

Support for one or more specific data types in computing is a fundamental and important feature of a computing system. From a hardware perspective, for a computing system to support a data type, it is necessary to design various units such as an operation processing unit and a decoding control unit that are suitable for that data type on the hardware. The design of these units will undoubtedly increase the circuit area of the hardware, which will result in larger power consumption. From a software perspective, for a computing system to support a data type, corresponding changes are required be made to an underlying software compiler, a function library, and a software stack of a top-level architecture. For an intelligent computing system, the use of different data types may also affect the algorithm precision in the intelligent computing system. Therefore, the choice of data type has an important impact on the hardware design, software stack, algorithm precision, etc. of the intelligent computing system. In view of this, how to improve the algorithm precision of the intelligent computing system with fewer hardware efficacy and software stack support is an urgent technical challenge.

### SUMMARY

In view of the technical problems referred to in the background above, the present disclosure proposes, in various aspects, a processing apparatus, a device, a method for neural network operating, and related products. Specifically, the scheme of the present disclosure converts the data type of an operation result of the neural network into a preset data type with lower data precision, which is suitable for data storage and transfer within an on-chip system and/or between the on-chip system and an off-chip system, thereby improving the algorithm precision and reducing power consumption and cost of computation under the conditions of lower hardware area power consumption and software stack support.

In addition, the disclosed scheme also improves the performance and precision of the intelligent computing system as a whole. The neural network of the embodiments in the present disclosure may be applied to various fields, such as image processing, speech processing, text processing, and the like. These processes may, for example, include, but are not limited to, identification and classification.

A first aspect of the present disclosure provides a processing apparatus. The processing apparatus includes an operator configured to perform at least one operation to obtain an operation result, and a first type converter configured to convert a data type of the operation result into a third data type, where the data precision of the data type of the operation result is greater than the data precision of the third data type, and the third data type is suitable for storage and transfer of the operation result.

A second aspect of the present disclosure provides an edge device for neural network operating, which includes an on-chip system of the first aspect of the present disclosure, and the on-chip system is configured to engage in training and/or inference of the neural network at the edge device.

A third aspect of the present disclosure provides a cloud device for neural network operating, which includes the on-chip system of the first aspect of the present disclosure, and the on-chip system is configured to engage in training and/or inference of the neural network at the cloud device.

A fourth aspect of the present disclosure provides a neural network system capable of cloud-edge collaborative computing, which includes a cloud computing sub-system configured to perform operations related to the neural network on the cloud, an edge computing sub-system configured to perform operations related to the neural network on the edge, and the processing apparatus of the first aspect of the present disclosure, where the processing apparatus is arranged at the cloud computing sub-system and/or the edge computing sub-system, and is configured to participate in a training process of the neural network and/or an inference process based on the neural network.

A fifth aspect of the present disclosure provides a method for neural network operating, which is performed by the processing apparatus. The method includes: performing at least one operation to obtain an operation result, and converting a data type of the operation result into a third data type, where the data precision of the data type of the operation result is greater than the data precision of the third data type, and the third data type is suitable for storage and transfer of the operation result.

A sixth aspect of the present disclosure provides a computer program product including a computer program that, when executed by a processor, implements the on-chip system of the first aspect of the present disclosure.

By adopting the processing apparatus, the device, the method for neural network operating, and related products provided above, the scheme of the present disclosure converts the data type of the operation result of the neural network into a preset data type with lower data precision, which is suitable for data storage and transfer within the on-chip system and/or between the on-chip system and the off-chip system, thereby improving the algorithm precision and reducing power consumption and cost of computation under the conditions of lower hardware area power consumption and software stack support. In addition, the disclosed scheme also improves the performance and precision of the intelligent computing system as a whole.

### BRIEF DESCRIPTION OF DRAWINGS

By reading the following detailed description with reference to accompanying drawings, the above-mentioned and other objects, features and technical effects of exemplary embodiments of the present disclosure will become easy to understand. In the accompanying drawings, several embodiments of the present disclosure are shown in an exemplary but not restrictive manner, and the same or corresponding reference numerals indicate the same or corresponding parts of the embodiments.

FIG. 1 illustrates a schematic diagram of an example of a convolution operation process.

FIG. 2 illustrates a schematic diagram of an example of a maximum pooling operation process.

FIG. 3 illustrates a schematic diagram of an example of a fully connected operation process.

FIG. 4 illustrates a functional block diagram of a processing apparatus according to an embodiment of the present disclosure.

FIG. 5 illustrates a schematic diagram of an example of a 32-bit floating-point number.

FIG. 6 illustrates a schematic diagram of an example of a 16-bit floating-point number.

FIG. 7 illustrates a functional block diagram of a processing apparatus according to another embodiment of the present disclosure.

FIG. 8 is a schematic diagram of the internal structure of the processing apparatus in the present disclosure when it has a multi-core architecture.

FIG. 9 illustrates a schematic diagram of an example of a TF32 floating-point number.

FIG. 10 illustrates a flow chart of a method for neural network operating according to an exemplary embodiment of the present disclosure.

FIG. 11 illustrates a structural diagram of a combined processing apparatus according to an embodiment of the present disclosure.

FIG. 12 illustrates a schematic structural diagram of a board card according to an embodiment of the present disclosure.

### DETAILED DESCRIPTION OF EMBODIMENTS

Technical solutions in embodiments of the present disclosure will be described clearly and completely hereinafter with reference to the drawings in the embodiments of the present disclosure. Obviously, the embodiments to be described are merely some rather than all embodiments of the present disclosure. All other examples obtained by those skilled in the art based on the embodiments of the present disclosure without creative efforts shall fall within the protection scope of the present disclosure.

Artificial Neural Networks (ANNs), also referred to as neural networks (NNs), are algorithmic mathematical models for distributed parallel information processing that mimic the behavioral characteristics of the animal neural network. The neural network is a machine learning algorithm that includes at least one neural network layer. The types of layers in the neural network include a convolutional layer, a fully connected layer, a pooling layer, an activation layer, a BN (Batch Normalization) layer, and the like. Various layers related to the scheme of the present disclosure are briefly described below.

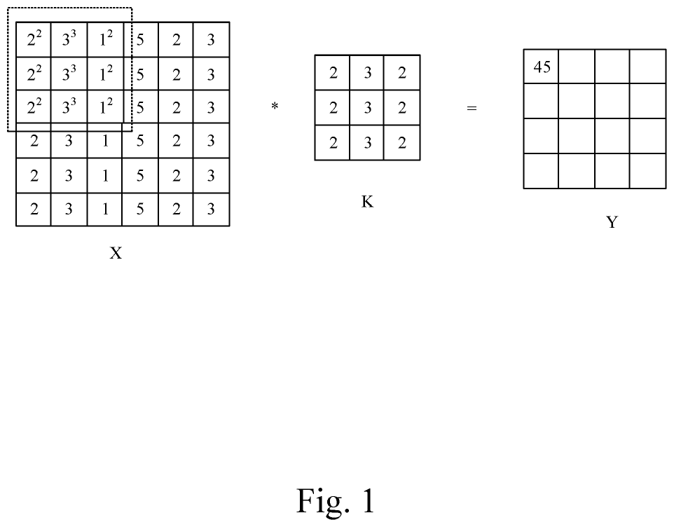

The convolutional layer of the neural network may perform a convolution operation, and the convolution operation may be performing a matrix inner product of an input feature matrix and a convolution kernel. FIG. 1 illustrates a schematic diagram of an example of a convolution operation process. As shown in FIG. 1, an input of the convolutional layer is a feature matrix X, and the size of the matrix X is 6×6; and a convolution kernel K is a 3×3 matrix. In order to compute a first value Y0,0 of an output matrix Y, the center of the convolution kernel K is placed at the (1, 1) position of the matrix X. By multiplying coefficients of the matrix X at corresponding position and coefficients of the convolution kernel one by one and then adding products together, a following formula and a result may be obtained:

Y_{0.0}=X_{0.0}×K_{0.0}+X_{0.1}×K_{0.1}+X_{0.2}×K_{0.2}+X_{1.0}×K_{1.0}+X_{1.1}×K_{1.1}+X_{1.2}×K_{1.2}+X_{2.0}×K_{2.0}+X_{2.1}×K_{2.1}+X_{2.2}×K_{2.2}=2×2+3×3+1×2+2×2+3×3+1×2+2×2+3×3+1×2=45.

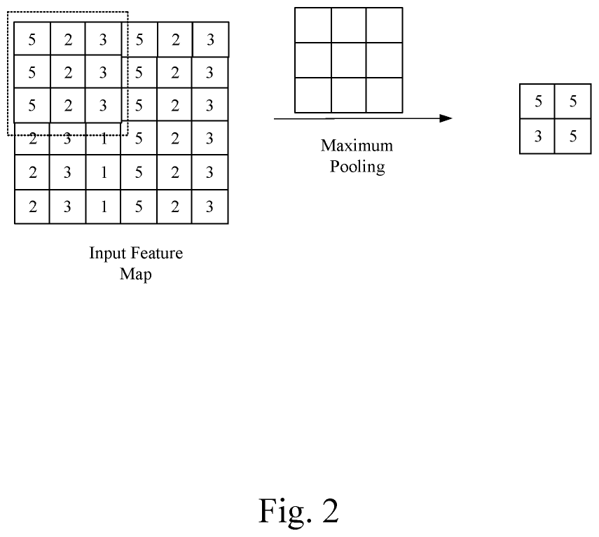

The pooling layer of the neural network may perform a pooling operation with the purpose of reducing the number of parameters and the amount of computation and suppressing overfitting. The operators used for the pooling operation include maximum pooling, average pooling, L2 pooling, and the like. For ease of understanding, FIG. 2 illustrates a schematic diagram of an example of a maximum pooling operation process. As shown in FIG. 2, a pooling window is 3×3 with a step size of 3. A maximum value 5 is found by the pooling window as a first output from a 3×3 sub-matrix in the upper left corner of an input feature map. The pooling window is shifted to the right by 3 frames on the input feature map to find the maximum value 5 as a second output, and the pooling window continues to slide downward to get all output values.

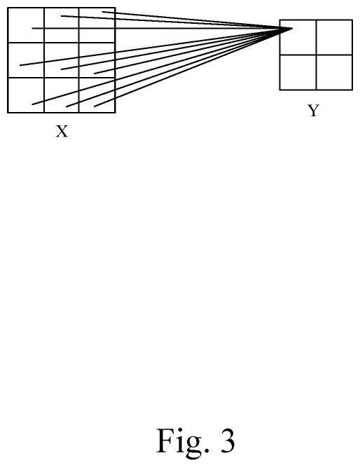

The fully connected layer of the neural network may perform a fully connected operation. The fully connected operation may map a high-dimensional feature into a one-dimensional feature vector which contains all the feature information of the high-dimensional feature. Similarly, for ease of understanding, FIG. 3 illustrates a schematic diagram of an example of a fully connected operation process. As shown in FIG. 3, an input of the fully connected layer is a feature matrix X, and the size of the matrix X is 3×3. In order to compute a first value Y0,0 of an output matrix Y, all coefficients of the matrix X are required to be multiplied with corresponding weights at each position one by one, and then products are added together, a following formula may be obtained:

$${Y}_{0 , 0} = {X}_{0 , 0} \times {W}_{0 , 0} + {X}_{0 , 1} \times {W}_{0 , 1} + {X}_{0 , 2} \times {W}_{0 , 2} + {X}_{1 , 0} \times {W}_{1 , 0} + {X}_{1 , 1} \times {W}_{1 , 1} + {X}_{1 , 2} \times {W}_{1 , 2} + {X}_{2 , 0} \times {W}_{2 , 0} + {X}_{2 , 1} \times {W}_{2 , 1} + {X}_{2 , 2} \times {W}_{2 , 2} .$$

The activation layer of the neural network may perform an activation operation, and the activation operation may be realized by an activation function. The activation function may include a sigmoid function, a tanh function, an ReLU function, a PReLU function, an ELU function, and the like. The activation function may provide nonlinear features to the neural network.

A BN layer of the neural network may perform a Batch Normalization (BN) operation. Normalization with a plurality of samples may normalize an input to a standard normal distribution with added parameters, and the process of the Batch Normalization operation is as follows.

If an input of a certain neural network layer is xi (i=1, . . . , M, M is the size of a training set), xi=[xi1; xi2; . . . ; xid] are d-dimensional vectors, and each dimension k of xi is first normalized,

$$= \frac{{x}_{ik} - E [ {x}_{ik} ]}{\sqrt{Var [ {x}_{ik} ]}}$$

then scaling and shifting are performed on normalized values to get values after the BN operation:

$${y}_{ik} = \cdot {γ}_{k} + {β}_{k} ,$$

where γₖ and βₖ are scaling and offset parameters of each dimension.

It should be noted that the present disclosure illustrates, for the purpose of example only, the operations of the neural network in conjunction with the convolutional layer, the fully connected layer, the pooling layer, the activation layer, and the BN layer of the neural network. The present disclosure is not in any case limited to the types of operations of the neural network described above. Specifically, operations involved in other types of layers of the neural network (such as a long short-term memory (“LSTM”) layer and a local response normalization (“LRN”) layer.) fall within the scope of protection of the present disclosure.

Specific embodiments of the present disclosure are described in detail with reference to the drawings below.

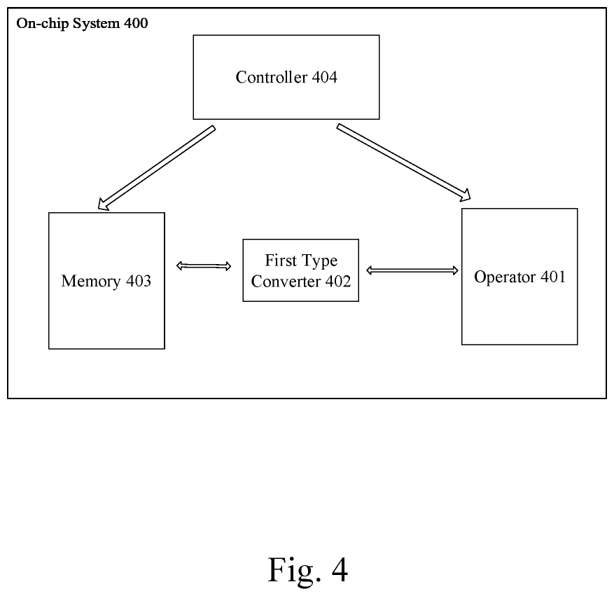

FIG. 4 illustrates a functional block diagram of a processing apparatus according to an embodiment of the present disclosure. As shown in FIG. 4, a processing apparatus 400 includes an operator 401, a first type converter 402, a memory 403, and a controller 404. In one implementation scenario, the controller 404 may be configured to control the coordinated work of the operator 401 and the memory 403 to accomplish tasks of machine learning. The operator 401 is configured to perform at least one operation to obtain an operation result. Optionally, the operator may be configured to perform neural network-related operations, including, but not limited to, a multiplication operation, an addition operation, an activation operation, and other operations. An operation result obtained by the operator may be an operation result obtained by the operator performing a portion of the operations. Alternatively, an operation result obtained by the operator may be an operation result obtained by the operator performing all of the operations. The memory 403 is configured to store or transfer data. According to the scheme of the present disclosure, the first type converter 402 may be configured to convert a data type of the operation result obtained by the operator 401 to an operation result in the third data type. The data precision of the data type of the operation result obtained by the operator 401 may be greater than the data precision of the third data type, and the third data type is suitable for storage and transfer of the operation result.

Data in the neural network includes a variety of data types, such as integer numbers, floating-point numbers, complex numbers, boolean numbers, strings, and quantized integer numbers. These data types may be further subdivided depending on the data precision (the bit length in the context of the present disclosure). For example, integer numbers include 8-bit integer numbers, 16-bit integer numbers, 32-bit integer numbers, 64-bit integer numbers, and the like. Floating-point numbers include half-precision (float16) floating-point numbers, single-precision (float32) floating-point numbers, and double-precision (float64) floating-point numbers. Complex numbers include 64-bit single-precision complex numbers, 126-bit double-precision complex numbers, and the like. Quantized integer numbers include quantized 8-bit integer numbers (qint8), quantized 16-bit integer numbers (qint16), and quantized 32-bit integer numbers (qint32).

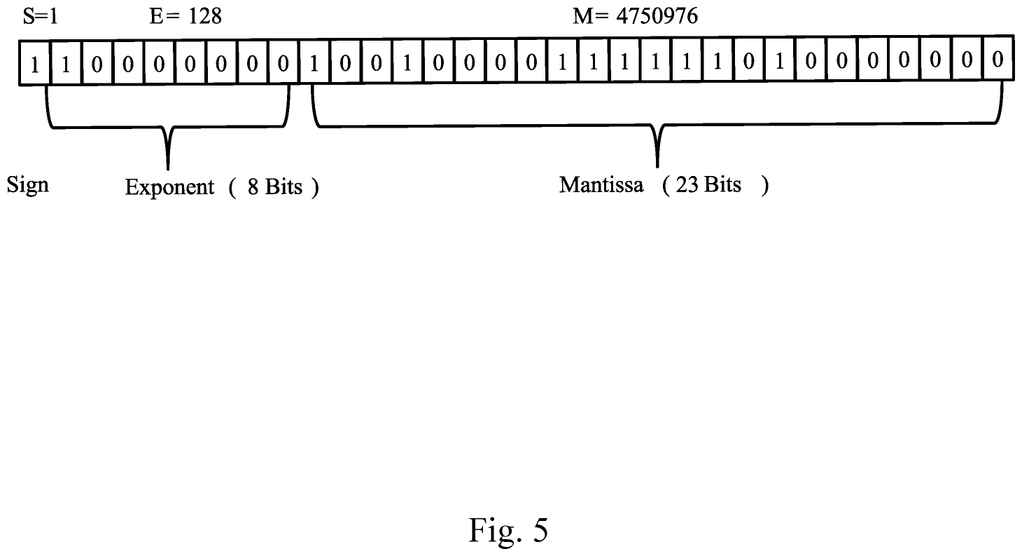

To facilitate understanding of the meaning of data precision in the present disclosure, FIG. 5 illustrates a schematic diagram of an example of a 32-bit floating-point number. As shown in FIG. 5, a 32-bit floating-point number (single precision) consists of a 1-bit sign(s), an 8-bit exponent (e), and a 23-bit mantissa (m). The sign s=0 represents a positive sign, the sign s=1 represents a negative sign, the exponent e has a value range of 0-255, and the mantissa m is also called the decimal place. A truth value of the number represented in FIG. 5 is expressed in binary as “(−1)(1.1001000011111101)×2128−127”, which is converted to decimal as “−3.132720947265625”.

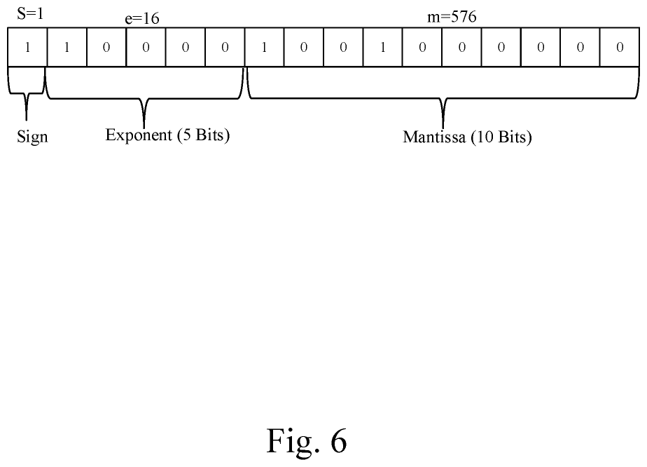

FIG. 6 illustrates a schematic diagram of an example of a 16-bit floating-point number. As shown in FIG. 6, a 16-bit floating-point number (half precision) consists of a 1-bit sign(s), a 5-bit exponent (e), and a 10-bit mantissa (m). The sign s=0 represents a positive sign, the sign s=1 represents a negative sign, the exponent e has a value range of 0-31, and the mantissa m is also called the decimal place. A truth value of the number represented in FIG. 6 is expressed in binary as “(−1)(1.1001)×2¹⁶⁻¹⁵”, which is converted to decimal as “−3.125”.

For the floating-point data type, the data precision is related to the number of bits of mantissa (m). The more bits of mantissa (m) are, the higher the data precision is. In view of this, it is understood that the data precision of a 32-bit floating-point number is greater than the data precision of a 16-bit floating-point number. Considering this situation, the operator 401 of the present disclosure may adopt a data type with higher precision, such as adopting a 32-bit single-precision floating-point number, when performing an operation of the neural network. Thereafter, the operator 401, after obtaining an operation result with higher precision, may transmit the operation result to the first type converter 402, and the first type converter 402 performs the conversion from high-precision data to low-precision data.

Although in practice, in order to ensure the precision of the algorithm in the neural network, the neural network will adopt a higher data precision in the operation, but the higher the data precision requires more bandwidth and storage space. In view of this, the memory 403 in the scheme of the present disclosure adopts a data type with low bit width and low precision to store or transfer data. Accordingly, the third data type may be a data type with low-width or low-precision used to store or transfer data in the memory 403, such as a TF32 floating-point number described in more detail below. Based on the foregoing considerations, in this embodiment, the first type converter 402 may perform a conversion from a high-precision operation result to a low-precision third data type. It should be clear that the low bit-width and low-precision of the data type herein are relative to the bit-width and precision of the data type adopted by the operator to perform the operation.

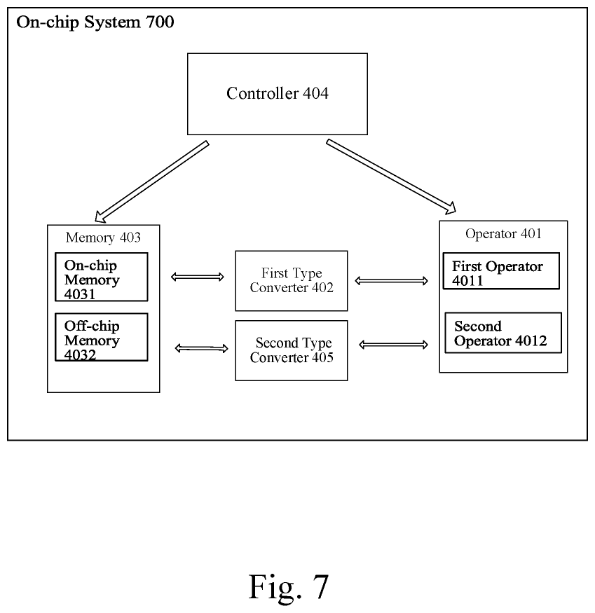

FIG. 7 illustrates a functional block diagram of a processing apparatus used for an operation of a neural network according to another embodiment of the present disclosure. Based on the foregoing description, those skilled in the art may understand that the processing apparatus shown in FIG. 7 may be a possible concrete implementation of the processing apparatus illustrated in FIG. 4, and thus the previous description of the processing apparatus in conjunction with FIG. 4 applies equally well to the description below in conjunction with FIG. 7.

As shown in FIG. 7, a processing apparatus 700 includes an operator 401, a first type converter 402, a memory 403, and a controller 404. The operator 401 includes a first operator 4011 and a second operator 4012, where the first operator 4011 is configured to perform a first type operation in a first data type to obtain an operation result of the first type operation, and the second operator 4012 is configured to perform a second type operation on the operation result of the first type operation in a second data type to obtain an operation result of the second type operation as well as to perform a nonlinear layer operation of the neural network on the operation result of the second type operation to obtain the result of the nonlinear layer operation in the second data type. The first operator 4011 and the second operator 4012 may be vector operators or matrix operators, which are not specifically limited herein.

When data and an operation in the neural network are represented by a data type with a certain data precision, a computing unit in the hardware is required to adapt to the data with this data precision. For example, an operator with this data precision may be used. In this embodiment, the first data type has a first data precision, the second data type has a second data precision, and the third data type has a third data precision. The first operator 4011 may be a first data precision operator, and the second operator 4012 may be a second data precision operator. Exemplarily, the first operator 4011 may be a 16-bit floating-point operator number and the second operator 4012 may be a 32-bit floating-point number operator. Here the first type operation may be one of operations of the neural network (such as a pooling operation) or a specific type operation (such as a multiplication operation); the second type operation may be one of operations of the neural network (such as a convolution operation) or a specific type operation (such as an addition operation). Optionally, the first type operation may be a multiplication operation, and the second type operation may be an addition operation. In this case, the first data precision may be less than the second data precision, and the third data precision may be less than the first data precision and/or the second data precision.

In this embodiment, the first type converter 402 may be configured to convert the result of the nonlinear layer operation into an operation result in a third data type. As an example, the result of the aforementioned nonlinear layer operation may have a second data precision, and the second data precision may be greater than the third data precision.

In some other embodiments, the first data type has a data precision of low bit length, the second data type has a data precision of high bit length, and the third data type has a data precision that is less than the data precision of the first data type and/or the data precision of the second data type. Optionally, the third data type has a data precision between the data precision of low bit length of the first data type and the data precision of high bit length of the second data type. In the context of the present disclosure, the bit length of a data type refers to the number of bits required to represent that data type. Taking a data type of a 32-bit floating-point number as an example, the 32-bit floating-point number requires 32 bits, so the bit length of the 32-bit floating-point number is 32. Similarly, the bit length of a 16-bit floating-point number is 16. Based on this, the bit length of the second data type is higher than the bit length of the first data type, and the bit length of the third data type is higher than the bit length of the first data type and lower than the bit length of the second data type. Optionally, the first data type may include a 16-bit floating-point number with 16-bit length, the second data type may include a 32-bit floating-point number with 32-bit length, and the third data type may include a TF32 floating-point number with 19-bit length.

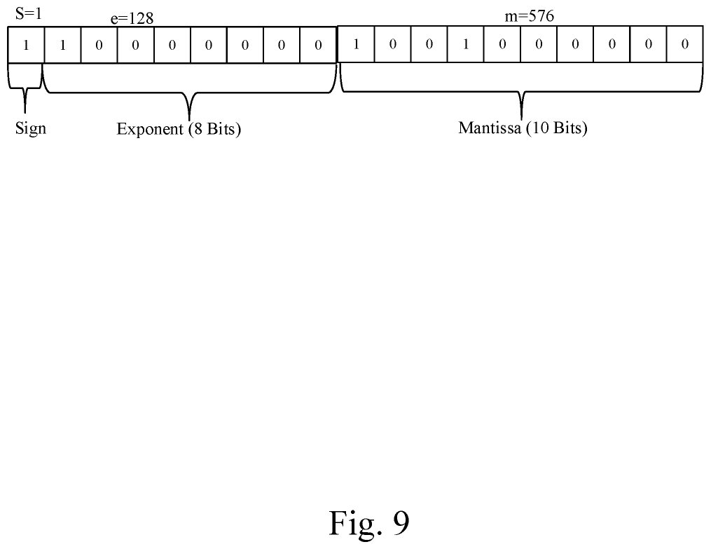

To facilitate understanding of the data precision of the TF32 floating-point number in the present disclosure, FIG. 9 illustrates a schematic diagram of an example of a TF 32 floating-point number. As shown in FIG. 9, a TF32 floating-point number consists of a 1-bit sign(s), an 8-bit exponent (e), and a 10-bit mantissa (m). The sign s-0 represents a positive sign, the sign s=1 represents a negative sign, the exponent e has a value range of 0-255, and the mantissa m is also called the decimal place. A truth value of the number represented in FIG. 9 is expressed in binary as “(−1)(1.1001)×2128−127”, which is converted to decimal as “-3.125”.The TF32 floating-point number uses the same 10-bit mantissa as the 16-bit floating-point number and the same 8-bit exponent as the 32-bit floating-point number. Since the TF32 floating-point number uses the same 10-bit mantissa as the16-bit floating-point number, the TF32 floating-point number may meet algorithm precision requirements of the neural network; and since the TF32 floating-point number also uses the same 8-bit exponent as the 32-bit floating-point number, so that the TF32 floating-point number may support the same range of numbers as the 32-bit floating-point number.

As another embodiment of the third data type, the third data type may also include a truncated half-precision floating-point number bf16. A bf16 consists of a 1-bit sign(s), an 8-bit exponent (e), and a 7-bit mantissa (m). The meaning of sign, exponent, and mantissa of the bf16 is the same or similar to that of the 16-bit floating-point number and the32-bit floating-point number, which will not be repeated here.

When the third data type is bf16, the second operator 4012 may perform a second type operation on the result of the first type operation in the type of TF32 floating-point number to obtain the result of the second type operation. Then, the nonlinear layer operation of the neural network may be performed on the operation result of the second type operation to obtain a nonlinear layer operation result in the type of TF32 floating-point number. Thereafter, according to the scenario or requirement of the operation, the first type converter 402 may further convert the nonlinear layer operation result in the type of TF32 floating-point number into a nonlinear layer operation result in the type of bf16.

It is noted that the memory 403 in the present disclosure may adopt the TF32 floating-point number or the bf16 to store or transfer data. In addition, when the nonlinear layer operation result with the second data precision is converted into the operation result in the type of TF32 floating-point number, the scheme of the present disclosure may reduce the power consumption and cost of computation, and also improve the performance and precision of the intelligent computing system as a whole.

In some other embodiments, the first type converter 402 is also configured for data type conversion between different operations of the neural network. Since different operations of the neural network may adopt data types with different data precisions (for example, the convolution operation adopts the data type of 16-bit floating-point number, and the activation operation adopts the data type of 32-bit floating-point number), the first type converter 402 may be used for data type conversion between operations adopting different data precisions. The data type conversion herein may be either the conversion from a high-precision operation to a low-precision operation, or the conversion from a low-precision operation to a high-precision operation.

In some other embodiments, the first type converter 402 is further configured to convert the operation result in the third data type into the first data type or the second data type for subsequent operations of the first operator or the second operator. Specifically, the first type converter 402 may convert the operation result obtained by the operator 401 by performing the operation of the neural network operation into an operation result in the third data type and store the operation result to the memory 403. If the controller 404 issues an instruction to continue performing the operation of the neural network on the operation result in the third data type, the memory 403 may send the operation result in the third data type to the first type converter 402 to perform the data type conversion, and send the obtained operation result in the first data type or the second data type to the operator 401 to perform the subsequent neural network operations. If the first type converter 402 converts the operation result in the third data type into the operation result in the first data type, the subsequent neural network operations may be performed by the first operator 4011; if the first type converter 402 converts the operation result in the third data type into the operation result in the second data type, the subsequent neural network operations may be performed by the second operator 4012.

In some other embodiments, the processing apparatus 700 further includes a second type converter 405 configured to convert the operation result in the third data type into the first data type or the second data type for subsequent operations of the first operator or the second operator. The first type converter 402 may convert an operation result obtained by the operator 401 by performing an operation of the neural network operation into an operation result in the third data type and store the operation result to the memory 403. If the controller 404 issues an instruction to continue performing the operation of the neural network on the operation result in the third data type, the memory 403 may send the operation result in the third data type to the second type converter 405 to perform the data type conversion, and send the obtained operation result in the first data type or the second data type to the operator 401 to perform the subsequent neural network operations. If the second type converter 405 converts the operation result in the third data type into the operation result in the first data type, the subsequent neural network operations may be performed by the first operator 4011; if the second type converter 405 converts the operation result in the third data type into the operation result of the second data type, the subsequent neural network operations may be performed by the second operator 4012.

In some other embodiments, the first type converter 402 and/or the second type converter 405 are configured to perform a truncation operation on the operation result by using the truncation method based on a nearest neighbor principle or a preset truncation method to achieve the data type conversion. The following takes a decimal number as an example to illustrate the truncation method based on the nearest neighbor principle. If the third data type is a floating-point number 3.4, and the first data type or the second data type is an integer number, the data conversion process of the first type converter 402 is as follows: finding an integer number 3 that is closest to the floating-point number 3.4, and converting the floating-point number 3.4 to the integer number 3. If the third data type is an integer number 3, and the first data type or the second data type is a floating-point number with one decimal point precision. The data conversion process of the second type converter 405 is as follows: finding a floating-point number 3.1 or 2.9 that is closest to the integer number 3, and converting the integer number 3 to the floating-point number 3.1 or 2.9.

Depending on implementation scenarios, the preset truncation method may be any truncation method configured by users. The following takes a decimal number as an example to illustrate a preset truncation method. It is assumed that the third data type of the present disclosure is a floating-point number 3.5, and the first data type or the second data type is an integer number, the preset truncation method is to look upwards for the nearest number. Based on this hypothetical scenario, the data conversion process of the first type converter 402 in the present disclosure may be as follows: looking upward for an integer number that is closest to the floating-point number 3.5, i.e., the integer number 4, and converting the floating-point number 3.5 to the integer number 4. Similarly, if the third data type is an integer number 3, and the first data type or the second data type is a floating-point number with one decimal point precision. The data conversion process of the second type converter 405 is as follows: looking upward for a floating-point number that is closest to the integer number 3, such as a floating-point number 3.1, and converting the integer number 3 to the floating-point number 3.1.

As can be seen from the above description, the first type converter 402 and/or the second type converter 405 of the present disclosure may perform the data type conversion either by using the truncation method based on the nearest neighbor principle or by using the preset truncation method. Additionally or alternatively, the first type converter 402 and/or the second type converter 405 may perform perform the data type conversion by using the truncation method based on the nearest neighbor principle and the preset truncation method. Accordingly, the present disclosure does not limit herein the types of truncation methods and the manner in which the truncation methods may be used.

In some other embodiments, the processing apparatus 700 further includes at least one on-chip memory 4031, where the on-chip memory may be a memory inside the processing apparatus. Depending on different implementations, the processing apparatus 700 of the present disclosure may be implemented as a single-core processor or a processor with a multi-core architecture.

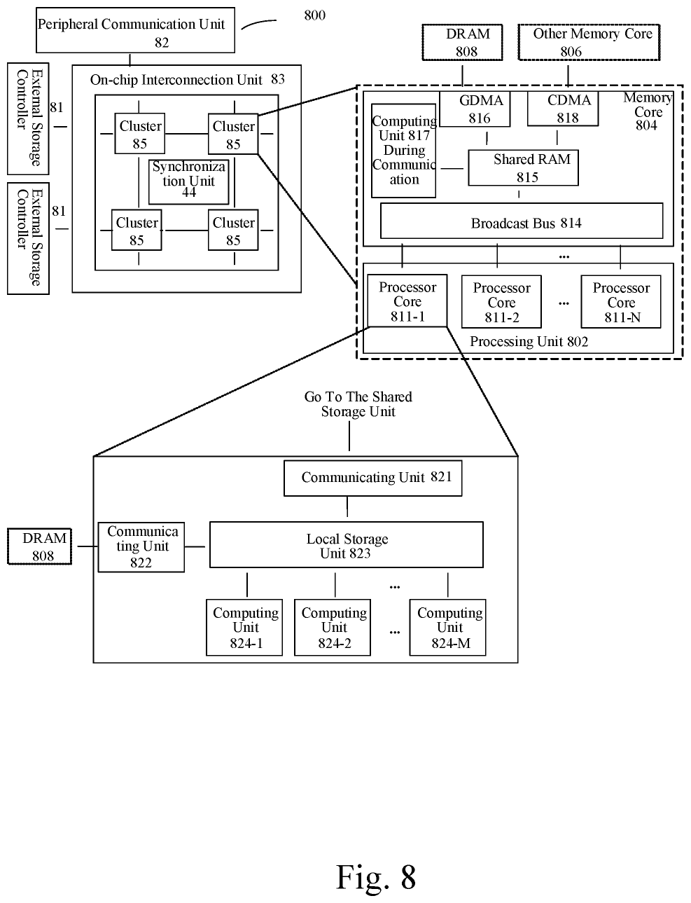

FIG. 8 is a schematic diagram of the internal structure of the processing apparatus 700 when it has a multi-core processor architecture. For ease of description, the processing apparatus 700 having a multi-core architecture is hereinafter referred to as a multi-core processing apparatus 800. According to the scheme of the present disclosure, computing resources of the multi-core processing apparatus 800 may be designed in a hierarchical structure and may be implemented as an on-chip system. Further, the multi-core processing apparatus 800 may include at least one cluster, and each cluster may include a plurality of processor cores. Each processor core may include at least one computing unit 824-m, and each computing unit may be at least one of multipliers, adders, nonlinear operators, and other operators.

As shown in FIG. 8, storage resources of the multi-core processing apparatus 800 may also be designed in a hierarchical structure. Each processor core 811 may have a local storage unit 823 required for the execution of computing tasks, which may specifically include an NRAM (non-volatile random-accessed memory) and a WRAM (window random access memory) (not shown in the figure). Each cluster 85 may have a shared storage unit 815 that may be accessed by a plurality of processor cores 811-n inside the cluster. Specifically, a local storage unit 823 inside the processor core may interact with the shared storage unit for data interaction via a communicating unit 821. The plurality of clusters may be connected to one or more off-chip memories DRAM (dynamic random access memory) 808, therefore a shared storage unit inside each cluster may interact with the DRAM 408, and a processor core inside each cluster may interact with the off-chip memory DRAM 408 via the communicating unit.

In one embodiment, a processor core in the multi-core processing apparatus 800 may be used in at least one operation to obtain an operation result. The operation result may be converted to the third data type and transferred and stored in the form of the third data type between storage resources at various levels of the multi-core processing apparatus 800. Specifically, the third data type (such as the TF32) of the present disclosure transfers the operation result from the local storage unit to an SRAM (static random-access memory) and is temporarily stored in the SRAM. When the operation result is required for subsequent operations of the processor core (in other words, there is a dependency between previous and subsequent operations), the temporarily stored data in the third data type such as the TF32 may be converted to the first or second data type required by the processor core to perform an operation. Alternatively, if it is determined that the operation result is still required for subsequent operations of the processor core, the operation result may be stored temporarily in the local storage unit or the SRAM in the original data type (the first or second data type), thereby reducing the data conversion operation.

Due to the limited on-chip storage space, when the operation result will not be reused, then the operation result may also be stored on an off-chip DRAM. In one case, the operation result in the original data type (the first or second data type) is temporarily stored in the local storage unit or the SRAM. At this time, when the operation result will not be reused, the operation result may be converted to the third data type, and the operation result in the third data type may be stored in the off-chip DRAM. In another case, the processor core converts the obtained operation result into data in the third data type after completing the relevant operation, and at this time, when the operation result will not be reused, the operation result in the third data type stored in the local storage unit or SRAM may be stored in the off-chip DRAM. Optionally, in the process of storing the data to the off-chip DRAM, data compression may be performed on the operation result in the third data type to further reduce the IO (input and output) overhead.

According to different operating scenarios, the various types of devices of the present disclosure may be used individually or in combination to realize various types of operation, for example, the processing apparatus of the present disclosure may be suitable for a forward inference operation and a reverse training operation of the neural network. Specifically, in some embodiments, one or more of the first operator 4011, the second operator 4012, the first type converter 402, and the second type converter 405 of the present disclosure are configured to perform one or more of the following operations: an operation that is directed to an output neuron in a neural network inference process, an operation that is directed to gradient propagation in a neural network training process, and an operation that is directed to weight updating in the neural network inference process. For ease of understanding, the training, forward and backward propagation, and updating operations of the neural network are briefly described below.

The neural network is trained by adjusting parameters of hidden and output layers, so that results computed by the neural network are close to real results. During the training process, the neural network mainly includes two processes: forward propagation and back propagation. In the forward propagation (also known as forward inference), an input target computes the hidden layer by weights, bias and an activation function, and the hidden layer gets a next hidden layer by the weights, bias and the activation function of the next level, and after iterating layer by layer, an input feature vector is progressively extracted from a low-level feature to an abstract feature, finally a target classification result is output. A basic principle of backpropagation is that a loss function is first computed based on the result of the forward propagation and the true value, then a gradient descent method is used to compute the partial derivative of the loss function for each weight and bias through a chain rule., i.e., the effect of the weight or bias on the loss, and finally the weights and biases are updated. Here, the process of computing the output neuron based on a trained neural network model is an operation on the output neuron in the neural network inference process. The back propagation during the neural network training includes a gradient propagation operation and a weight updating operation.

In some embodiments, in the above-mentioned neural network inference process and/or neural network training process, the first type operation of the present disclosure may include a multiplication operation, the second type operation may include an addition operation, and the nonlinear layer operation may include an activation operation. The multiplication operation here may be either a multiplication operation in a convolution operation or a multiplication operation in a fully connected operation. Similarly, the addition operation here may be either an addition operation in the convolution operation or an addition operation in the fully connected operation. The present disclosure does not limit the types of neural network operation of multiplication or addition. In addition, the aforementioned nonlinear layer may be an activation layer in the neural network.

Similar to the specific operations described previously, during the neural network inference process and/or the neural network training process, the first operator 4011 of the present disclosure may perform a first type operation in the first data type to obtain a result of the first type operation. Accordingly, the second operator 4012 is configured to perform a second type operation on the operation result of the first type operation in a second data type to obtain an operation result of the second type operation as well as to perform a nonlinear layer operation of the neural network on the operation result of the second type operation to obtain the result of the nonlinear layer operation in the second data type. As previously mentioned, the first data type may have a first data precision, the second data type may have a second data precision, and the first data precision is less than the second data precision. Then, the first type converter 402 converts the result of the nonlinear layer operation into an operation result in the third data type. Here, the data precision of the third data type may be less than the first data precision or the second data precision.

For example, the neural network may include a convolutional layer and an activation layer. During the forward inference operation of the neural network, the operator may first perform the convolution operation (including the multiplication operation and the addition operation) to obtain a result of the convolution operation. The first type converter may convert the data type of the result of the convolution operation to the third data type, so that the operation result may be stored in on-chip storage space or transferred to off-chip storage space. For example, the data type of the input data of the convolution operation is FP16, and the data type of the result of the convolution operation is TF32. Moreover, the operator of the processing apparatus may use the result of the convolution operation as an input to perform the activation operation, at this time, the first type converter or the second type converter may convert the result of the convolution operation in the third data type to a data type required by the operator of the processing apparatus to perform the activation operation. For example, the first data type converter or the second type converter is used to convert the result of the convolution operation in the TF32 data type to the FP16 or FP32 data type required for the activation operation. The operator may perform the activation operation to obtain a result of the activation operation based on the result of the convolution operation. The first type converter may convert the data type of the result of the activation operation to the third data type, so that the result of the activation operation may be stored in the on-chip storage space or transferred to the off-chip storage space. For example, the first data type converter is used to convert the data type of the result of the activation layer operation from FP32 to TF32.

In one embodiment, due to the data dependency between the convolution operation and the activation operation, intermediate results of the respective operations may be stored in the on-chip storage space to reduce the IO overhead. At this point, the data type conversion process of intermediate results such as the result of the convolution operation may be omitted, which may reduce the number of on-chip data conversions and improve the operational efficiency. Further, the processing apparatus may compute the loss function based on the result of the activation operation. During the inverse operation of the neural network, the processing apparatus may obtain an output gradient of the activation layer based on the loss function, after which an operation of gradient propagation and an operation of weight updating are performed based on this output gradient. In the operation of gradient propagation, the operator of the processing apparatus may compute a gradient of an input layer of a current output layer based on an output gradient and a weight of the current output layer. The gradient of each input layer may be used as an operation result. The first type converter may convert the data type of the operation result to the third data type, so that the operation result may be stored in the on-chip storage space or transferred to the off-chip storage space. When there is a data dependency between the operations in the layers of the neural network, the intermediate results of each operation may also be stored in the on-chip storage space to reduce the IO overhead. At this time, the data type conversion process of intermediate results such as the gradient of the convolutional layer may be omitted, which may reduce the number of on-chip data conversions and improve operational efficiency.

In the operation of weight updating, the processing apparatus may compute to obtain a gradient of inter-layer weight updating based on an output gradient of the current output layer and a neuron of the input layer of the current output layer. Each gradient of inter-layer weight updating may be used as an operation result. The first type converter may convert the data type of the operation result to the third data type, so that the operation result may be stored in the on-chip storage space or transferred to the off-chip storage space. Afterwards, the processing apparatus may compute to obtain updated weight data based on the weight updating gradient and weight data before being updated (the weight data before being updated may be stored in the third data type in the off-chip memory). At this time, the first type converter or the second type converter of the processing apparatus may convert the weight updating gradient of the third data type and the weight data before being updated to a data type required for an operator of the processing apparatus to perform the weight updating, and the operator may perform an operation to obtain updated weight data based on the weight updating gradient and the weight data before being updated. Finally, the first type converter may convert the data type of the updated weight to the third data type to store the updated weight to the off-chip storage space.

In some embodiments, the multiplication operation (the first type operation in the present disclosure) among the neural network operations may be performed using a 16-bit floating-point number operator (equivalent to the first operator in the present disclosure), and then the addition operation (the second type operation in the present disclosure) on the result of the multiplication operation may be performed using a 32-bit floating-point number operator (equivalent to the second operator in the present disclosure), and a convolution result in the type of 32-bit floating-point number after the execution of the aforementioned multiplication and addition operations is output. Then, a 32-bit floating-point number operator is used in the activation layer of the neural network model to perform the nonlinear layer operation on the convolution result. An obtained result of the nonlinear layer operation in the type of 32-bit floating-point number may be converted to a result of the nonlinear layer operation in the type of TF32 floating-point number (i.e., the third data type in the present disclosure) in accordance with a truncation method based on the nearest neighbor principle and a user-configurable truncation method.

In some scenarios, the on-chip system may perform data moving of the result of the nonlinear layer operation in the type of TF32 floating-point number between an off-chip memory (such as the DRAM) and an on-chip memory (SRAM), an on-chip memory (SRAM) and an on-chip memory (SRAM), and an off-chip memory (such as the DRAM) and an off-chip memory (such as the DRAM). In some scenarios, when the neural network model is still required to perform operations on the result of the nonlinear layer operation in the type of TF32 floating-point number, the result of the nonlinear layer operation in the type of TF32 floating-point number is converted to the result of the nonlinear layer operation in the type of 16-bit floating-point number and/or to the result of the nonlinear layer operation in the type of 32-bit floating-point number in accordance with a truncation method based on the nearest neighbor principle and/or the user-configurable truncation method.

In some embodiments, the processing apparatus 400 of the present disclosure may further include a compressor configured to compress the operation result with the third data precision for data storage and transfer within the on-chip system and/or between the on-chip system and the off-chip system. In one scenario, the compressor may be provided between the operator 403 and the memory 401 for performing data type conversion (such as the conversion for the third data type) to facilitate data storage and transfer within the on-chip system and/or between the on-chip system and the off-chip system.

Depending on the application scenario, the on-chip system of the present disclosure may be flexibly arranged at a suitable position of an artificial intelligence system, such as the edge layer and/or the cloud. In view of this, the present disclosure provides an edge device for neural network operating, which includes the on-chip system according to any one of the exemplary embodiments of the present disclosure, and the on-chip system is configured to engage in training and/or inference of the neural network at the edge device. The edge device herein may include devices such as cameras, smartphones, gateways, wearable computing devices, and sensors at the edge of the network. Similarly, the present disclosure provides a cloud device for neural network operating, which includes the on-chip system according to any one of the exemplary embodiments of the present disclosure, and the on-chip system is configured to engage in the training and/or inference of the neural network at the cloud device. The cloud device herein may include cloud servers or board cards that are implemented based on the cloud technology. Here, the aforementioned cloud technology may refer to a hosting technology that unifies a series of resources such as hardware, software, and network within a wide area network or a local area network to enable the computation, storage, processing, and sharing of data.

In addition, the present disclosure provides a neural network system capable of cloud-edge collaborative computing, which includes a cloud computing sub-system configured to perform operations related to the neural network on the cloud, an edge computing sub-system configured to perform operations related to the neural network on the edge, and the on-chip system according to any one of the exemplary embodiments, where the on-chip system is arranged at the cloud computing sub-system and/or the edge computing sub-system, and is configured to participate in the training process of the neural network and/or the inference process based on the neural network.

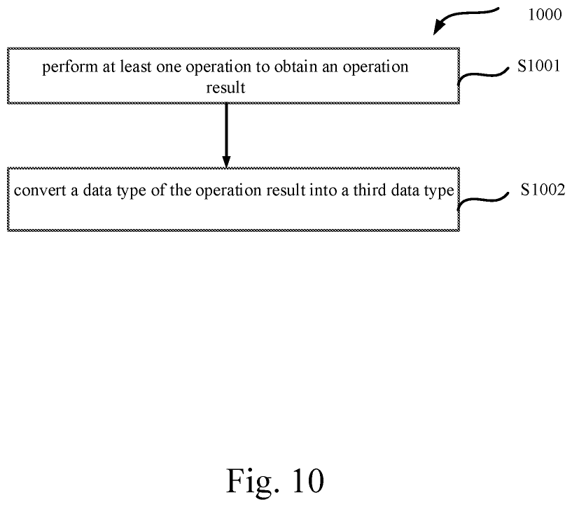

After introduced the on-chip system of the exemplary embodiments of the present disclosure, the method for neural network operating of the exemplary embodiments of the present disclosure is next described with reference to FIG. 10.

As shown in FIG. 10, the method 1000 for neural network operating is performed by the on-chip system. A step S1001 includes: performing at least one operation to obtain an operation result; a step S1002 includes: converting a data type of the operation result into a third data type, where the data precision of the data type of the operation result is greater than the data precision of the third data type, and the third data type is suitable for data storage and transfer within the on-chip system and/or between the on-chip system and the off-chip system.

In view of the fact that the steps of the method 1000 are the same as the operation of the processing apparatus 400 in FIG. 4, the description with respect to the processing apparatus 400 in FIG. 4 is equally applicable to the operation of the method 1000, and therefore further operations with respect to the method 1000 will not be repeated herein. Additionally, although other steps of the method 1000 are not described herein for the purpose of brevity, however, based on the foregoing description, those skilled in the art may understand that the method 1000 herein may also include various steps of the operation performed by the on-chip system illustrated in FIG. 7 or FIG. 8.

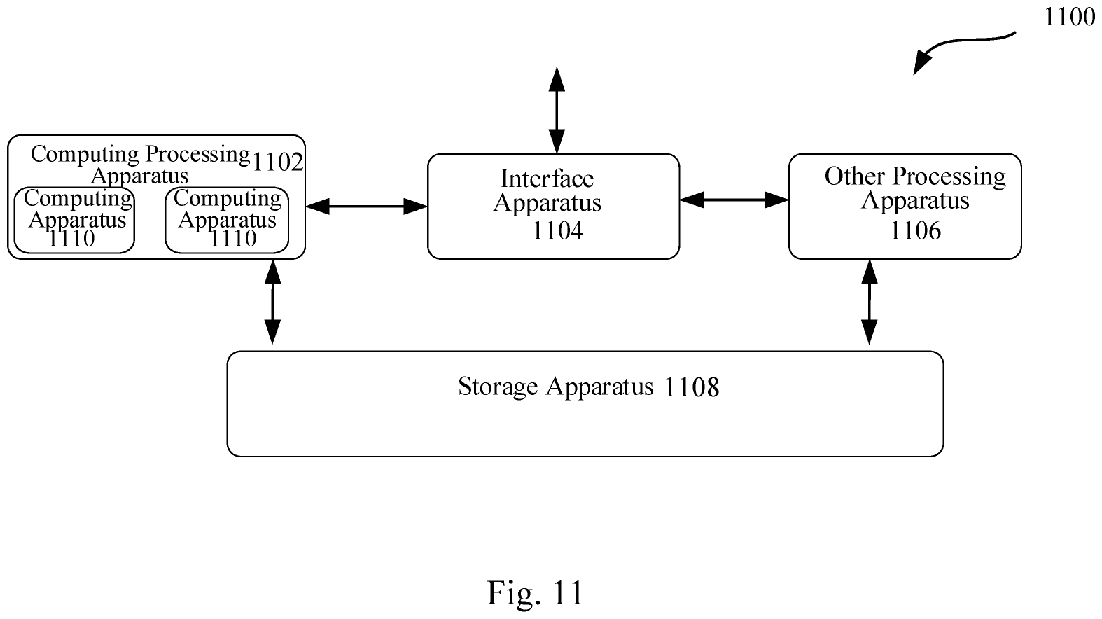

FIG. 11 is a structural diagram of a combined processing apparatus according to an embodiment of the present disclosure. It is understood that the combined processing apparatus disclosed herein may be used to perform the data type conversion described above in the present disclosure in conjunction with the accompanying drawings. In some scenarios, the combined processing apparatus may include the on-chip system as described above in the present disclosure in conjunction with the accompanying drawings. In some other scenarios, the combined processing apparatus connects with the on-chip system described above in the present disclosure in conjunction with the accompanying drawings in order to execute an executable program obtained according to the above-described method for neural network operating.

As shown in FIG. 11, the combined processing apparatus 1100 may include a computing processing apparatus 1102, an interface apparatus 1104, other processing apparatus 1106, and a storage apparatus 1108. According to different application scenarios, the computing processing apparatus may include one or a plurality of computing apparatuses 1110, and the computing apparatus may be configured to perform various types of operations, such as various types of operations involved in machine learning in the field of artificial intelligence.

In different embodiments, the computing processing apparatus of the present disclosure may be configured to perform an operation specified by a user. In an exemplary application, the computing processing apparatus may be implemented as a single-core artificial intelligence processor or a multi-core artificial intelligence processor. As a result, the arithmetic codes described above in the present disclosure in conjunction with the accompanying drawings may be executed in an intelligent processor. Similarly, one or a plurality of computing apparatuses included in the computing processing apparatus may be implemented as an artificial intelligence processor core or a partial hardware structure of the artificial intelligence processor core. If the plurality of computing apparatuses are implemented as artificial intelligence processor cores or partial hardware structures of the artificial intelligence processor cores, the computing processing apparatus of the present disclosure may be regarded as having a single-core structure or an isomorphic multi-core structure.

Exemplarily, the computation processing apparatus of the present disclosure is shown in FIG. 8. According to scheme of the present disclosure, the computation processing apparatus 800 may be designed in a hierarchical structure and may be implemented as an on-chip system. Further, the multi-core processing apparatus 800 may include at least one cluster, and each cluster may include a plurality of processor cores. In other words, the computation processing apparatus 800 is composed of an SoC (System on Chip)-cluster-processor core hierarchy.

In terms of the SoC hierarchy, as shown in FIG. 8, the computation processing apparatus 800 includes an external storage controller 81, a peripheral communication unit 82, an on-chip interconnection unit 83, a synchronization unit 84, and a plurality of clusters 85. There may be a plurality of external storage controllers 81, two of which are exemplarily shown in the figure. The external storage controllers 81 are configured to, in response to an access request from processor cores, access an external storage apparatus, such as the DRAM 408, so as to read or write data from off-chip. The on-chip interconnection unit 83 connects the external storage controller 81, the peripheral communication unit 82, and the plurality of clusters 85, and is used for transferring data and the control signal among the units. The synchronization unit 84 is a GBC (global barrier controller), and is used to coordinate the work progress of each cluster to ensure the synchronization of information. The plurality of clusters 85 are the computing cores of the multi-core processing apparatus 800, and four clusters are exemplarily shown in the figure. With the development of hardware, the multi-core processing apparatus 800 of the present disclosure may also include 8, 16, 64, or even more clusters 85. The clusters 85 are configured to efficiently execute deep learning algorithms.

In terms of the cluster hierarchy, as shown in the upper right of FIG. 8, each cluster 85 includes a processing unit 802 and a memory core (MEM core) 804. The processing unit 802 performs various computational tasks. In some implementations, the processing unit may be a multi-core architecture, for example, the processing unit may comprise a plurality of processor cores (IPU (Image Processing Unit) cores) 811-1 to 811-n, to complete tasks such as large-scale vector computing. The present disclosure does not limit the number of processor core 811.

The internal architecture of the processor core 811 is shown at the bottom of FIG. 8. Each processor core 811 may have a plurality of computing units 824-1 to 824-m for performing computational tasks, as well as a local storage unit 823 required for performing the computational tasks. It is to be particularly noted that the local storage unit 823 may include various communication units to exchange data with an external storage unit. For example, the local storage unit 823 may include a communication unit 821 to communicate with a shared storage unit 815 in the memory core 804. The communication unit 821 may, for example, be a move direct memory access (MVDMA) unit. The local storage unit 823 may also include a communication unit 822 to exchange data with the off-chip memory, such as a DRAM 408. The communication unit 822 may, for example, be an input/output direct memory access (IODMA) unit. The IODMA unit 822 controls the access of the NRAM/WRAM in the local storage unit 823 to the DRAM 408; the MVDMA unit 821 controls the access of the NRAM/WRAM in the local storage unit 823 to the shared storage unit 815.

Back to the upper right view of FIG. 8, the memory core 804 is primarily used for storage and communication; in other words, the memory core 804 is primarily used to store shared data or intermediate results among the processor cores 811 and execute communication between the clusters 85 and the DRAM 408, communication between each cluster 85 and each other cluster 405, and communication between each processor core 811 and each other processor core 811. In other embodiments, the memory core 804 has the ability to perform a scalar operation, and is used to perform the scalar operation to implement computational tasks during data communications.

The memory core 804 includes a larger SRAM (shared RAM) 815, a broadcast bus 814, a CDMA (cluster direct memory access) 818, a GDMA (global direct memory access) 816 and a computing unit 817 during communication. The SRAM 815 assumes the role of a high-performance data transit station. Data reused between different processor cores 811 in the same cluster 85 may not be obtained from the DRAM 408 through the processor cores 811, but transferred through the SRAM 815 in the processor cores 811. Therefore, the memory core 804 is only required to quickly distribute the reused data from the SRAM 815 to a plurality of processor cores 811, which may improve the communication efficiency between the processor cores 811 and significantly reduce the on-chip and off-chip input/output access.

The broadcast bus 814, the CDMA 818, and the GDMA 816 are used to perform the communication among the processor cores 811, the communication among the clusters 85, and the data transmission between the clusters 85 and the DRAM 808, respectively, which will be described separately below.

The broadcast bus 814 is used to complete high-speed communication among the processor cores 811 in the clusters 85. The broadcast bus 814 of the embodiment supports inter-core communication including unicast, multicast, and broadcast. The unicast refers to point-to-point (such as a single processor core to a single processor core) data transmission; the multicast refers to a communication mode in which a piece of data is transferred from the SRAM 815 to certain processor cores 811; and the broadcast refers to a communication mode in which a piece of data is transferred from the SRAM 815 to all processor cores 811. The broadcast is a special case of the multicast.

The GDMA 816 works in conjunction with the external storage controller 81 to control the access from the SRAM 815 to the DRAM 808 in the clusters 85, or to read data from the

DRAM 808 to the SRAM 815. From the above description, the communication between the DRAM 808 and the NRAM/WRAM in the local storage unit 823 may be implemented through two channels. A first channel is to directly connect the DRAM 808 with the local storage unit 823 through the IODMA 822. A second channel is to transfer the data between the DRAM 808 and the SRAM 815 through the GDMA 816 first, and then to transfer the data between the

SRAM 815 and the local storage unit 823 through the MVDMA 821. Although it seems that the second channel requires more components and longer data streams, in fact, in some embodiments, the bandwidth of the second channel is much greater than that of the first channel. Therefore, the communication between the DRAM 808 and the local storage unit 823 may be more efficient through the second channel. Embodiments of the present disclosure may select a data transfer channel according to hardware conditions.

In some embodiments, the memory core 804 may be used as a cache level within a cluster 85, which is large enough to broaden the communication bandwidth. Further, the memory core 804 may also accomplish communication with other clusters 85. The memory core 804 implements, for example, the communication function such as broadcast, scatter, gather, reduce and all-reduce between clusters 85. The broadcast refers to broadcasting and distributing the same data to all clusters; the scatter refers to distributing different data to different clusters; the gather refers to gathering data from a plurality of clusters; the reduce refers to computing the data in a plurality of clusters according to a specified mapping function to get a final result and sending the result to a particular cluster; the difference between the all-reduce and the reduce is that the final result of the reduce is sent to only one cluster, whereas a final result of the all-reduce is sent to all clusters.

The computing unit 817 during communication may be used to complete the computational tasks in the communication process, such as the above-mentioned reduce and all-reduce, without resorting to the processing unit 802, so as to improve the communication efficiency and achieve the effect of “storage and communication as a whole”. Depending on different hardware implementations, the computing unit 817 during communication and the shared storage unit 815 may be integrated in the same or different components, which is not limited in the embodiments of the present disclosure. As long as the implemented functions and the achieved technical effects are similar to those of the present disclosure, no matter the computing unit 817 during communication and the shared storage unit 815 is integrated in the same or different components, they fall within the scope of protection of the present disclosure.

Further as shown in FIG. 8, a plurality of processor cores form four processor clusters, and each processor cluster may comprise a plurality of processor cores. The plurality of processor cores are all capable of accessing the shared storage unit SRAM 815 and storing data of the shared storage unit SRAM 815. The processor cores of each processor cluster may also access the off-chip memory DRAM provided externally to the processing apparatus and store data of the off-chip memory DRAM provided externally to the processing apparatus.

In an exemplary operation, the computing processing apparatus of the present disclosure interacts with other processing apparatus through the interface apparatus to jointly complete the operation specified by the user. According to different implementations, other processing apparatus of the present disclosure may include one or more kinds of general-purpose and/or special-purpose processors, including a CPU (central processing unit), a GPU (graphics processing unit), an artificial intelligence processor, and the like. These processors may include but are not limited to a DSP (digital signal processor), an ASIC (application specific integrated circuit), an FPGA (field-programmable gate array), or other programmable logic devices, discrete gate or transistor logic devices, discrete hardware components, and the like. The number of the processors may be determined according to actual requirements. As described above, the computing processing apparatus of the present disclosure may be regarded as having the single-core structure or the isomorphic multi-core structure. However, when considered together, both the computing processing apparatus and other processing apparatus may be regarded as forming a heterogeneous multi-core structure.

In one or a plurality of embodiments, other processing apparatus may serve as an interface that connects the computing processing apparatus (which may be embodied as an artificial intelligence computing apparatus such as a computing apparatus for a neural network operation) of the present disclosure to external data and control. Other processing apparatus may perform basic controls that include but are not limited to data moving, and starting and/or stopping the computing apparatus. In another embodiment, other processing apparatus may also cooperate with the computing processing apparatus to jointly complete an operation task.

In one or a plurality of embodiments, the interface apparatus may be used to transfer data and a control instruction between the computing processing apparatus and other processing apparatus. For example, the computing processing apparatus may obtain input data from other processing apparatus via the interface apparatus and write the input data to an on-chip storage apparatus (or called a memory) of the computing processing apparatus. Further, the computing processing apparatus may obtain the control instruction from other processing apparatus via the interface apparatus and write the control instruction to an on-chip control caching unit of the computing processing apparatus. Alternatively or optionally, the interface apparatus may further read data in the storage apparatus of the computing processing apparatus and then transfer the data to other processing apparatus. In some scenarios, the interface apparatus may also be implemented as an application programming interface such as a driver interface between the computing processing apparatus and other processing apparatuses to pass various instructions and programs to be executed by the computing processing apparatus between the computing processing apparatus and other processing apparatuses.

Additionally or optionally, the combined processing apparatus of the present disclosure may further include a storage apparatus. As shown in the figure, the storage apparatus is connected to the computing processing apparatus and other processing apparatus, respectively. In one or a plurality of embodiments, the storage apparatus may be used to store data of the computing processing apparatus and/or other processing apparatus. For example, the data may be data that may not be fully stored in the internal or the on-chip storage apparatus of the computing processing apparatus or other processing apparatus.

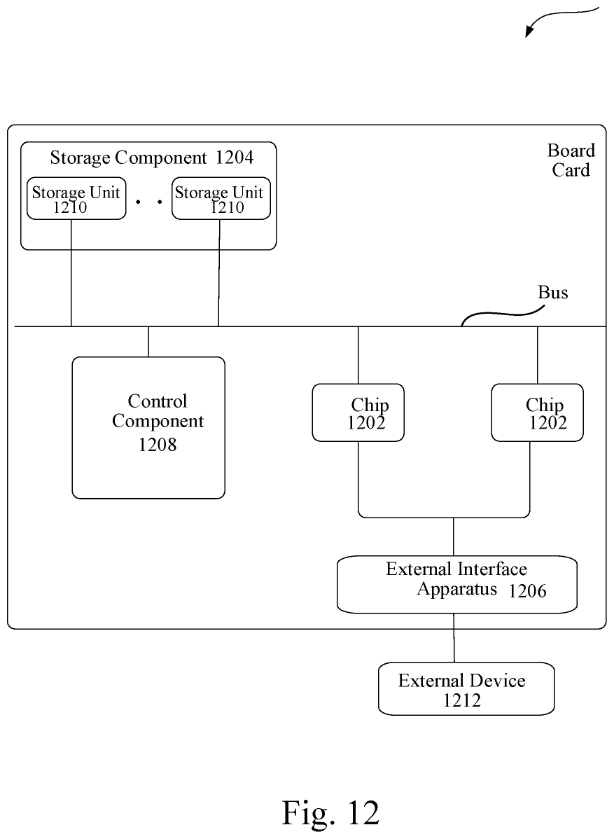

In some embodiments, the present disclosure also discloses a chip (such as a chip 1202 shown in FIG. 12). In an implementation, the chip may be an SoC (system on chip). The chip may be connected to other related components through an external interface apparatus (such as an external interface apparatus 1206 shown in FIG. 12). The related components may be, for example, a camera, a monitor, a mouse, a keyboard, a network card, or a WIFI interface. In some application scenarios, the chip may integrate other processing units (such as a video codec) and/or interface units (such as a DRAM (dynamic random access memory) interface), and the like. In some embodiments, the present disclosure also discloses a chip package structure, including the chip above. In some embodiments, the present disclosure also discloses a board card, including the chip package structure above. The following will describe the board card in detail in combination with FIG. 12.

FIG. 12 is a schematic structural diagram of a board card 1200 according to an embodiment of the present disclosure. The board card 1200 may include an intelligent processor architecture as described in the present disclosure in conjunction with the accompanying drawings. As shown in FIG. 12, the board card may include a storage component 1204 used for storing data, which may include one or a plurality of storage units 1210. The storage component may connect to and transfer data with a control component 1208 and the aforementioned chip 1202 through a bus. Further, the board card may include an external interface apparatus 1206, which may be configured to implement data relay or transfer between the chip (or the chip in the chip package structure) and an external device 1212 (such as a server or a computer). For example, to-be-processed data may be transferred from the external device to the chip through the external interface apparatus. For another example, a computing result of the chip may be still sent back to the external device through the external interface apparatus. According to different application scenarios, the external interface apparatus may have different interface forms. For example, the external interface apparatus may adopt a standard PCIe (peripheral component interconnect express) interface.

In one or a plurality of embodiments, the control component in the board card of the present disclosure may be configured to regulate and control a state of the chip. As such, in an application scenario, the control component may include an MCU (micro controller unit), which may be used to regulate and control a working state of the chip.

According to the aforementioned descriptions in combination with FIG. 11 and FIG. 12, those skilled in the art may understand that the present disclosure also discloses an electronic device or apparatus, which may include one or a plurality of the aforementioned board cards, one or a plurality of the aforementioned chips, and/or one or a plurality of the aforementioned combined processing apparatuses.

According to different application scenarios, the electronic device or apparatus of the present disclosure may include a server, a cloud server, a server cluster, a data processing apparatus, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household electrical appliance may include a television, an air conditioner, a microwave oven, a refrigerator, an electric rice cooker, a humidifier, a washing machine, an electric lamp, a gas cooker, and a range hood; and the medical equipment may include a nuclear magnetic resonance spectrometer, a B-ultrasonic scanner, and/or an electrocardiograph. The electronic device or apparatus of the present disclosure may be further applied to Internet, Internet of Things, data center, energy, transfer, public management, manufacturing, education, power grid, telecommunications, finance, retail, construction sites, medical, and other fields. Further, the electronic device or apparatus of the present disclosure may be used in application scenarios including cloud, edge, and terminal related to artificial intelligence, big data, and/or cloud computing. In one or a plurality of embodiments, according to the solution of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or a plurality of embodiments, hardware information of the cloud device is compatible with that of the terminal device and/or the edge device. As such, according to the hardware information of the terminal device and/or the edge device, appropriate hardware resources may be matched from hardware resources of the cloud device to simulate hardware resources of the terminal device and/or the edge device, so as to complete unified management, scheduling, and collaborative work of terminal-cloud integration or cloud-edge-terminal integration.

It is required to be explained that for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be executed in other orders or simultaneously. Further, those skilled in the art may understand that the embodiments described in the present disclosure may be regarded as optional embodiments; in other words, actions and modules involved thereof are not necessarily required for the implementation of a certain solution or some solutions of the present disclosure. Additionally, according to different solutions, descriptions of some embodiments of the present disclosure have their own emphases. In view of this, those skilled in the art may understand that for parts that are not described in detail in a certain embodiment of the present disclosure, reference may be made to related descriptions in other embodiments.

For specific implementations, according to the present disclosure and under the teaching of the present disclosure, those skilled in the art may understand that several embodiments disclosed in the present disclosure may be implemented through other methods that are not disclosed in the present disclosure. For example, for units in the electronic device or apparatus embodiment mentioned above, the present disclosure divides the units on the basis of considering logical functions, but there may be other division methods during actual implementations. For another example, a plurality of units or components may be combined or integrated into another system, or some features or functions in the units or components may be selectively disabled. In terms of a connection between different units or components, the connection discussed above in combination with drawings may be direct or indirect coupling between the units or components. In some scenarios, the aforementioned direct or indirect coupling relates to a communication connection using an interface, where the communication interface may support electrical, optical, acoustic, magnetic, or other forms of signal transmission.

In the present disclosure, units described as separate components may or may not be physically separated. Components shown as units may or may not be physical units. The aforementioned components or units may be located in the same position or distributed to a plurality of network units. Additionally, according to actual requirements, some or all of the units may be selected to achieve purposes of the solution described in embodiments of the present disclosure. Additionally, in some scenarios, the plurality of units in the embodiments of the present disclosure may be integrated into one unit, or each of the units may be physically separated.

In some implementation scenarios, the aforementioned integrated unit may be implemented in the form of a software program unit. If the integrated unit is implemented in the form of the software program unit and sold or used as an independent product, the integrated unit may be stored in a computer-readable memory. Based on such understanding, if the solution of the present disclosure is embodied in the form of a software product (such as a computer-readable storage medium), the software product may be stored in a memory, and the software product may include several instructions used to enable a computer device (such as a personal computer, a server, or a network device, and the like) to perform part or all of steps of the method of the embodiments of the present disclosure. The foregoing memory may include but is not limited to an USB, a flash disk, an ROM (read only memory), an RAM (random access memory), a mobile hard disk, a magnetic disk, or an optical disc, and other media that may store a program code.

In some other implementation scenarios, the aforementioned integrated unit may be implemented in the form of hardware. The hardware may be a specific hardware circuit, which may include a digital circuit and/or an analog circuit. A physical implementation of a hardware structure of the circuit may include but is not limited to a physical component, and the physical component may include but is not limited to a transistor, or a memristor, and the like. In view of this, various apparatuses described in the present disclosure (such as the computing apparatus or other processing apparatus) may be implemented by an appropriate hardware processor, such as a CPU, a GPU, a FPGA, a DSP, and an ASIC. Further, the aforementioned storage unit or storage apparatus may be any appropriate storage medium (including a magnetic storage medium or a magneto-optical storage medium, and the like), such as an RRAM (resistive random access memory), a DRAM (dynamic random access memory), an SRAM (static random access memory), an EDRAM (enhanced dynamic random access memory), an HBM (high bandwidth memory), an HMC (hybrid memory cube), the ROM, and the RAM, and the like.

The foregoing may be better understood according to following articles:

A1. A processing apparatus, comprising
an operator configured to perform at least one operation to obtain an operation result; and
a first type converter configured to convert a data type of the operation result into a third data type, where data precision of the data type of the operation result is greater than data precision of the third data type, and the third data type is suitable for storage and transfer of the operation result.

A2. The processing apparatus of A1, comprising
a first operator configured to perform a first type operation in a first data type to obtain a result of the first type operation; and
a second operator configured to perform a second type operation on the result of the first type operation in a second data type to obtain a result of the second type operation, and perform a nonlinear layer operation of a neural network on the result of the second type operation to obtain a result of the nonlinear layer operation in the second data type; where the first type converter is configured to convert the result of the nonlinear layer operation into an operation result in the third data type.

A3. The processing apparatus of A2, where the first data type has data precision of low bit length, the second data type has data precision of high bit length, and data precision of the third data type is less than the data precision of the first data type and/or the data precision of the second data type.

A4. The processing apparatus of A3, where the first data type includes a half-precision floating-point data type, the second data type includes a single-precision floating-point data type, and the third data type includes a TF32 data type, where the TF32 data type has a 10-bit mantissa and an 8-bit exponent.

A5. The processing apparatus of A1, where the first type converter is also configured for data type conversion between different operations.

A6. The processing apparatus of A1, further comprising
a second type converter configured to convert the operation result in the third data type into the first data type or the second data type for subsequent operations of the first operator or the second operator.

A7. The processing apparatus of A6, where the first type converter and/or the second type converter are configured to perform a truncation operation on the operation result by using a truncation method based on a nearest neighbor principle or a preset truncation method to achieve the data type conversion.

A8. The processing apparatus of A1, further comprising
at least one on-chip memory configured to store the operation result in the third data type, and to interact data with at least one off-chip memory in the third data type.

A9. The processing apparatus of A1, further comprising
a compressor configured to compress the operation result in the third data type for storage and transfer.

A10. The processing apparatus of any one of A6-A9, where one or more of the first operator, the second operator, the first type converter, and the second type converter are configured to perform one or more of following operations:
an operation that is directed to an output neuron in an inference process of the neural network,
an operation that is directed to gradient propagation in a training process of the neural network, and
an operation that is directed to weight updating in the training process of the neural network.

A11. The processing apparatus of A10, where, in the inference process of the neural network and/or the training process of the neural network, the first type operation includes a multiplication operation, the second type operation includes an addition operation, and the nonlinear layer operation includes an activation operation.

A12. An edge device for neural network operating, comprising the processing apparatus of any one of A1-A11, where the processing apparatus is configured to engage in a training and/or an inference of a neural network at the edge device.

A13. A cloud device for neural network operating, comprising the processing apparatus of any one of A1-A11, and the processing apparatus is configured to engage in a training and/or an inference of a neural network at the cloud device.

A14. A neural network system capable of cloud-edge collaborative computing, comprising
a cloud computing sub-system configured to perform operations related to a neural network on the cloud;
an edge computing sub-system configured to perform operations related to the neural network on the edge; and
the processing apparatus of any one of A1-A11, where the processing apparatus is arranged at the cloud computing sub-system and/or the edge computing sub-system, and is configured to participate in a training process of the neural network and/or an inference process based on the neural network.

A15. A method for neural network operating, performed by the processing apparatus of any one of A1-A11, where the method for neural network operating comprises:
performing at least one operation to obtain an operation result; and
converting a data type of the operation result into a third data type,
wherein data precision of the data type of the operation result is greater than data precision of the third data type, and the third data type is suitable for storage and transfer of the operation result.

A16. A computer program product, comprising a computer program, where the method of A15 is implemented when the computer program is executed by a processor.

It should be understood that terms such as “first”, “second”, “third”, and “fourth” in the claims, the specification, and drawings are used for distinguishing different objects rather than describing a specific order. It should be understood that terms “including” and “comprising” used in the specification and the claims indicate the presence of a feature, an entity, a step, an operation, an element, and/or a component, but do not exclude the existence or addition of one or more other features, entities, steps, operations, elements, components, and/or collections thereof.

It should also be understood that terms used in the specification of the present disclosure are merely intended to describe specific embodiments rather than to limit the present disclosure. As being used in the specification and the claims of the disclosure, unless the context clearly indicates otherwise, singular forms “a”, “an”, and “the” are intended to include plural forms. It should also be understood that a term “and/or” used in the specification and the claims refers to any and all possible combinations of one or more of relevant listed items and includes these combinations.

As being used in this specification and the claims, a term “if” may be interpreted as “when”, or “once”, or “in response to a determination” or “in response to a case where something is detected” depending on the context. Similarly, phrases such as “if . . . is determined” or “if [the described conditions or events] are detected” may be interpreted as “once . . . is determined”, “in response to determining”, “once [the described conditions or events] are detected”, or “in response to detecting [the described conditions or events]”.

Although a plurality of embodiments of the present disclosure have been shown and described, it is obvious to those skilled in the art that such embodiments are provided only as examples. Those skilled in the art may think of many modifying, altering, and substituting methods without deviating from the thought and spirit of the present disclosure. It should be understood that alternatives to the embodiments of the present disclosure described herein may be employed in the practice of the present disclosure. The attached claims are intended to limit the scope of protection of the present disclosure and therefore to cover equivalents or alternatives within the scope of these claims.

What is claimed:

1. A processing apparatus, comprising
an operator configured to perform at least one operation to obtain an operation result; and
a first type converter configured to convert a data type of the operation result into a third data type, wherein data precision of the data type of the operation result is greater than data precision of the third data type, and the third data type is suitable for storage and transfer of the operation result.

2. The processing apparatus of claim 1, comprising
a first operator configured to perform a first type operation in a first data type to obtain a result of the first type operation; and
a second operator configured to perform a second type operation on the result of the first type operation in a second data type to obtain a result of the second type operation, and perform a nonlinear layer operation of a neural network on the result of the second type operation to obtain a result of the nonlinear layer operation in the second data type; wherein the first type converter is configured to convert the result of the nonlinear layer operation into an operation result in the third data type.

3. The processing apparatus of claim 2, wherein the first data type has data precision of low bit length, the second data type has data precision of high bit length, and data precision of the third data type is less than the data precision of the first data type and/or the data precision of the second data type.

4. The processing apparatus of claim 3, wherein the first data type includes a half-precision floating-point data type, the second data type includes a single-precision floating-point data type, and the third data type includes a TF32 data type, wherein the TF32 data type has a 10-bit mantissa and an 8-bit exponent.

5. The processing apparatus of claim 1, wherein the first type converter is also configured for data type conversion between different operations.

6. The processing apparatus of claim 1, further comprising
a second type converter configured to convert the operation result in the third data type into the first data type or the second data type for subsequent operations of the first operator or the second operator.

7. The processing apparatus of claim 6, wherein the first type converter and/or the second type converter are configured to perform a truncation operation on the operation result by using a truncation method based on a nearest neighbor principle or a preset truncation method to achieve the data type conversion.

8. The processing apparatus of claim 1, further comprising
at least one on-chip memory configured to store the operation result in the third data type, and to interact data with at least one off-chip memory in the third data type.

9. The processing apparatus of claim 1, further comprising
a compressor configured to compress the operation result in the third data type for storage and transfer.

10. The processing apparatus of claim 6, wherein one or more of the first operator, the second operator, the first type converter, and the second type converter are configured to perform one or more of following operations:
an operation that is directed to an output neuron in an inference process of the neural network,
an operation that is directed to gradient propagation in a training process of the neural network, and
an operation that is directed to weight updating in the training process of the neural network.

11. The processing apparatus of claim 10, wherein, in the inference process of the neural network and/or the training process of the neural network, the first type operation includes a multiplication operation, the second type operation includes an addition operation, and the nonlinear layer operation includes an activation operation.

12-14. (canceled)

15. A method for neural network operating, performed by a processing apparatus wherein the method for neural network operating comprises:
performing at least one operation to obtain an operation result; and
converting a data type of the operation result into a third data type,
wherein data precision of the data type of the operation result is greater than data precision of the third data type, and the third data type is suitable for storage and transfer of the operation result, and
wherein the apparatus includes:
an operator configured to perform at least one operation to obtain an operation result; and
a first type converter configured to convert a data type of the operation result into a third data type, wherein data precision of the data type of the operation result is greater than data precision of the third data type, and the third data type is suitable for storage and transfer of the operation result.

16. A non-transitory computer readable medium comprising instructions that, when executed by a processor, cause the processor to perform operations including:
performing at least one operation to obtain an operation result; and
converting a data type of the operation result into a third data type,
wherein data precision of the data type of the operation result is greater than data precision of the third data type, and the third data type is suitable for storage and transfer of the operation result.
